(19) United States
(12) Patent Application Publication
(10) Pub. No.: US 2014/0222413 A1
(43) Pub. Date: Aug. 7, 2014

(54) METHOD AND USER INTERFACE FOR CONTROLLING LANGUAGE TRANSLATIONS USING TOUCH SENSITIVE DISPLAY SCREENS

(71) Applicant: Alain Rossmann, Palo Alto, CA (US)

(72) Inventor: Alain Rossmann, Palo Alto, CA (US)

(73) Assignee: Klip, Inc., Palo Alto, CA (US)

(21) Appl. No.: 13/757,463

(22) Filed: Feb. 1, 2013

(51) Int. Cl. G06F 17/28

(52) U.S. Cl. CPC G06F 17/28
USPC 704/3

(57) ABSTRACT

As social networks such as Twitter become an integral part of a growing number of smartphone and tablet apps and other software, app users more frequently encounter brief foreign language comments from other users. The invention provides a convenient touch screen user interface and method by which a user, with a minimal set of finger touches, may request a translation of such foreign language comments without otherwise leaving the app display screen where the comment was originally found. By using the appropriate set of finger movements, the user's device can be directed to first initiate translation, and then display the translation in a user finger gesture controlled manner in which the comment may be viewed both in its original language and in the foreign language. When the user is satisfied, the app can then resume operations at its original initiating display screen.

### BACKGROUND OF THE INVENTION

1. Field of the Invention

This invention is in the field of user interfaces for smartphones, tablet computers, and other touch screen computerized device.

2. Description of the Related Art

As modern computer and communications technology has advanced, more and more of the world's communications is taking place by way of mobile, touch-screen-equipped, portable computerized devices with wireless network connectivity, such as smartphones and tablet computers.

Although the internal workings of such devices are extremely complex, much effort has been devoted to make the devices manageable by the general public. As a result, successful computerized devices of this type, exemplified by the popular Apple iOS, Google Android, and Microsoft Windows series, typically use various types of touch-screen-enhanced graphical user interfaces. These touch-screen-enhanced graphical user interfaces are typically designed with the goal of mapping the interactions between user's finger touches, and the system's corresponding graphical responses, into a new type of interactive paradigm that is intuitive, easy to remember, and also an effective way to control that particular device.

Examples of such finger-touch-based user interfaces include Ording, U.S. Pat. No. 7,469,381 entitled “List scrolling and document translation, scaling, and rotation on a touch-screen display; Ording et. al., U.S. Pat. No. 7,864,163 entitled “Portable electronic device, method, and graphical user interface for displaying structured electronic documents”; and Platzer et. al., U.S. Pat. No. 7,844,915 entitled “Application programming interfaces for scrolling operations”; all assigned to Apple Inc., Cupertino Calif.; and others.

As a result of these advances, it is now possible for the average person to pick up a smartphone or tablet computer and, with minimal or no training, use a standardized set of touch motions quickly and easily direct these devices to perform the user's commands. Because of this common set of standardized touch motions, a user can use their smartphone or table device to, for example, download a new software application (app), and begin using the new and unfamiliar (to the user) app almost immediately with little or no training, because this app will generally use a familiar set of touch controls and user interfaces.

Due largely to the Internet and mobile data networks, and the advent of inexpensive, low cost, computerized devices, online social networks have now become common. These social networks, exemplified by Facebook and Twitter, allow users who share similar interests to easily connect and exchange information. This information is often in the form of short comments, rather than elaborate discussions. Twitter, for example, even though it limits its users to a maximum of 140 characters per brief message (Tweet) has become highly popular as a method to exchange brief thoughts. These various user comments or tweets are often presented on a scrolling screen, usually in chronological order with the most recent tweet message at the top of the screen, slightly older tweets underneath the top tweet, and still later tweets at the bottom of the screen. Other software, such as games software (e.g. World of Warcraft), image exchange software (e.g. Pinterest), and the like also have social network like aspects where participants can comment on the user's game performance, photographic selections, and the like.

The Internet started in the United States, and in the early years language issues were not a problem because the bulk of all communications were in English. However in today's globalized world, where billions of individuals wish to communicate with each other in their native language, language barriers are becoming a problem.

To assist in overcoming language barriers, a number of Internet companies, here exemplified by Google, Inc., offer free online (Internet) computerized language translators and Application Programming Interfaces (API) by which software programs can access these computerized language translators. Here, for example, a user may manually enter in a word or sentence in a foreign language of interest, and the Google system will automatically translate this word or sentence into the user's desired target language. Currently the Google translator service supports 64 different languages, with another 11 languages presently in alpha test phase.

As another alternative, a user program can feed a section of text to be translated to the Google language translation API, and receive back the translated text. This can be done, for example, by sending commands such as: https://www.googleapis.com/language/translate/v2 {parameters}. More information regarding such language API can be found in the article by Quentin Zervaas, “Translating Text Using the Google Translate API and PHP, JSON and cURL”, available online at phpriot.com, 2011.

### BRIEF SUMMARY OF THE INVENTION

The invention is based, in part, on the insight that as social networks (which can relay comments from users from all over the world), are incorporated into an ever wider range of apps—for example gaming apps, video exchange apps, discussion apps, and the like, the chances of a user encountering multiple foreign language comments while using a social application are becoming ever larger.

The invention is also based, in part, on the observation that there are presently no easy ways to cope with this problem. At present, a user encountering foreign language comments, for example on a social media enabled smartphone app, has a limited range of options. Here the main way at present to translate such a comment would be to rather laboriously use a first series of touch-screen finger motions to cut a section of this foreign language writing, another series of finger motions to move over to a translation website (such as Google translate), and a third series of finger motions to paste the foreign language writing, and get the translation.

The invention is thus based, in part, on the insight that there is presently an unmet need for a standardized user interface for touch-screen-enabled computerized devices, usually mobile computerized devices, that will more easily allow a user, with a minimal set of finger motions and without otherwise interrupting the flow of the app, to quickly translate a foreign language text (writing) of interest, and glance at the translation while still seeing the overall context of where this foreign language appears (i.e. while having most of the app's original display screen still showing) then return to interacting with other aspects of the app of interest. The ability to retain context is particularly important, since the old adage, “out of sight, out of mind” often applies. That is, if the user is forced to change screens to understand a particular foreign language comment, then it is just too easy to lose track of the context surrounding the foreign text, which is an undesirable phenomenon that the invention is designed to avoid.

The invention is also based on the insight that because machine translation is imperfect, there will often be a need in such situations to allow a user to quickly move back and forth between the original and translated version of the text as at least a quick quality control check on the machine translation, all without causing the user to forget what else is going on in the app. For example, even though many words in a foreign language may be unfamiliar to a user, names, numbers, and URL addresses are often constant, and by enabling rapid scrolling back and forth, the user can verify that the translator program has not distorted this part of the text.

In this context, the limited size of the display screens in typical smartphones should be appreciated. Smartphones, which are designed to fit into one's pocket, often have display screens with a total diagonal measurement of approximately 4 inches. This is a relatively small amount of display screen area in which to fit an app user interface containing, in a portion of the app's screen, a brief comment in a foreign language, as well as a side-by-side translation of the comment and additional screen real estate needed for the translation interface.

The invention is also based on the insight that a touch-based translation user interface should allow a user to rapidly move between the original foreign language text, and the translation of this text, while also preserving as much of the other portions of the app (e.g. the context in which the particular foreign language comment appeared) on the screen as possible. It is important to stay on the app's screen where the foreign language writing was first encountered, and ideally continually keep much of this initial app display screen displayed throughout the process, so that the user does not forget the context in which the foreign language text was first encountered. This in turn allows the user to resume the normal flow of the app once the user's questions regarding the meaning of the foreign language text have been resolved. A touch-based translation user interface should also achieve these goals while, in some embodiments working within the tiny screen dimensions of a typical smartphone.

As will be discussed, in one embodiment, the invention may be a computer implemented method of simultaneously displaying original language writing and translated language writing on a portion of the touch sensitive display screen of a computerized device (often a mobile computerized device such as a smartphone or tablet computer). The invention will optionally be initially triggered by receiving a user initiated translation trigger (e.g. a translate and store trigger) event on a first location of a touch sensitive display screen of his device (often above the portion (first portion) of the user's smartphone screen where the foreign language writing is located). The invention will then often transmit the foreign language writing to the API of a local or remote language translation server, which in turn will use information pertaining to the original language of the writing, and the translation language that the user desires to do a machine translation of the writing, and transmit this translation back to the user's device.

On receiving a user touch show translation trigger event on this first location or first portion of the user display screen (again usually over the foreign language writing), according to the method, the device will replace at least portions of the original foreign language writing (located on the first location of the touch sensitive display screen) with at least portions of the translated language writing, and also locate this translation on the first location of the touch sensitive display screen. The net effect will be to produce, on at least a transient but user detectable length of time, a display screen showing a composite first location that displays at the same time at least portions of the original language writing and portions of the translation. In a preferred embodiment, by swiping a finger, the user can alternate back and forth among the two versions of the writing in this section of the display screen, while leaving the remaining portions of the display screen unaffected so that the user can easily keep track of the context of the app in which the foreign language comment originally appeared.

Again, as previously discussed, an additional advantage of the invention is that throughout the translation, the initial app or other software display screen where the foreign language writing was first encountered remains continually displayed to the user throughout the process. Thus once the user has finished reviewing that particular translation, the user can once again resume working with the app or other software process in a seamless manner, without risk of losing track of what the user was doing when the foreign language writing was first encountered.

### BRIEF DESCRIPTION OF THE DRAWINGS

FIG. 1 shows an example of a prior art smartphone social media app (here a Twitter app), displaying a mixture of short messages (tweets) from various uses throughout the world, most in English, but one in French. Here the dotted line corresponds to the first location of this display screen.

FIG. 2 shows the interaction between a first internet server, such as a social network server, that may be supplying various comments, including foreign language comments, to the user's computerized device, and a second internet server, such as a language translation server, that can receive various foreign language writings from the user's computerized device, translate them, and then transmit them back to the user's computerized device for subsequent display.

FIG. 3 shows a detail of the French tweet from FIG. 1, here showing the invention's touch controlled translation user interface inaction. Here by moving a finger, the user can scroll back and forth between the original French tweet, and an English translation of this French tweet. The middle of this scrolling process is shown in the middle section, which shows a portion of the English translation on the left, and a portion of the original French tweet on the right.

FIG. 4 again shows a detail of the French tweet from FIG. 1, here showing an alternative embodiment of the invention's touch controlled user interface interaction. Again as before, by moving a finger, the user can cause this portion of the screen to dissolve back and forth between the original French tweet and an English translation of this French tweet. The middle of the alternate embodiment's dissolve or fade-in/fade-out process is shown in the middle section, which shows a composite of both the English translation and the original French tweet on the screen at the same time.

FIG. 5 shows a flow chart showing some of the various software steps performed by the user's computerized device in response to foreign language writing input and touch commands from the user, as well as showing how the user's device interacts with a remote translation server.

FIG. 6 shows more details of some of the major software and hardware components of the user's touch screen equipped computerized device, in this case a mobile device such as a smartphone.

### DETAILED DESCRIPTION OF THE INVENTION

In this discussion, the term “writing” will often be used to describe foreign language text. This is simply because of the possibility that some foreign language comments could be transmitted as images rather than text. Thus the term “writing” is often used because this covers foreign languages transmitted as both images and text.

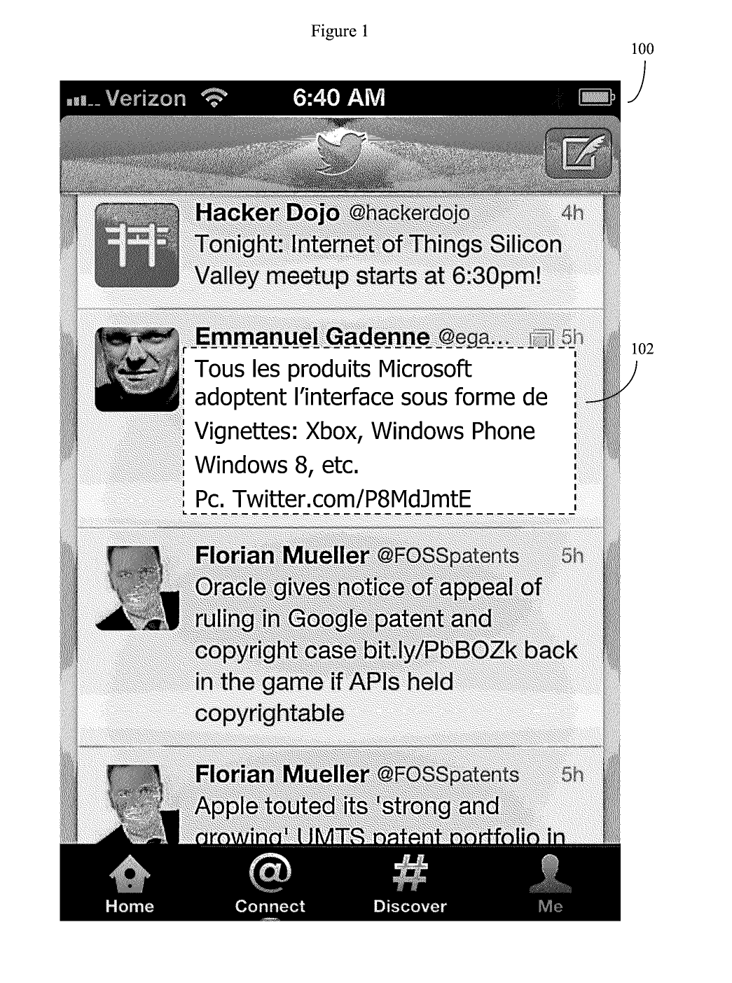

FIG. 1 shows an example of a screenshot of the touch-sensitive display screen of a prior art smartphone social media app (here a Twitter app). This app is displaying a mixture of short messages (tweets) from various uses throughout the world, most in English, but one in French. Here the area (102) that corresponds to the “first location” of this touch sensitive display screen, surrounding the French “tweet”, is shown as the dashed line. This first location of the touch sensitive display screen (102) is thus showing the original writing to be translated, according to the teaching of the present invention.

The invention may be considered to operate in three distinct phases, or to consist of three distinct elements. These are triggering the translation (initiating translation), performing the translation, and finally displaying the translation to the user (usually in response to a “show translation” finger touch command), often in a user interactive manner.

The first phase or element of the invention—triggering the translation, can occur in one or more of several alternative embodiments. The user may optionally trigger the translation process by, for example, executing an “initiate translation” command by touching or tapping the writing or a graphical element, such as a handle, that may be positioned by the system at the beginning of the foreign language text or writing of interest. In some embodiments, this initial tap may be used to signal the user's device to transmit the foreign language writing to a remote translation server, and receive the translated writing back in memory (602) for subsequent display.

Alternatively the user may initiate translation by pressing the touch sensitive display screen over the foreign language writing of interest (102) for some period of time—e.g. 1 or more seconds. This is called a “press and hold” operation. As yet another alternative, the user may initiate translation by double tapping or other multiple tapping on the touch sensitive display screen over the foreign language of interest (102). As yet another embodiment, the user may make another type of gesture, such as a rapid swipe, to initiate translation.

Either once the user's device has detected an initial trigger signal, or alternatively as an ongoing process that speculatively translates all foreign writing on the hopes that at least some of the translations will subsequently be useful for the user, the invention's methods will translate the writing. In some embodiments this can be done locally on the user's device itself. More commonly, however, in some embodiments, this may be done by having the user's device transmit the foreign language text to the API of a translation server, such as the previously discussed Google translator, or other machine translation device. Here network connected translation servers are often preferred for this purpose since they often have the capability to perform more accurate translation in more languages. However in situations where establishing a wireless connection to a remote server is considered undesirable, then the translation may be handled locally, often by using the user computerized device own processors and suitable translation software.

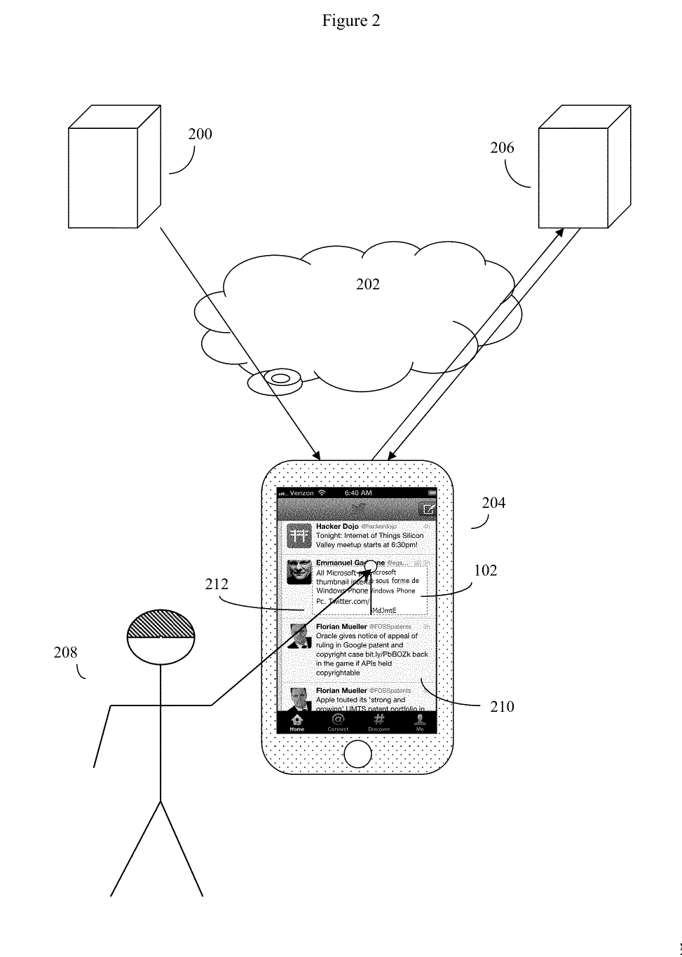

FIG. 2 shows the interaction between a first internet server (200), such as a social network server, that may be supplying various comments, including foreign language comments (e.g. original language writing), over a network such as the Internet (202) to the user's computerized device (204). This figure also shows a second internet server, such as a language translation server (e.g. computerized language translation server, such as the Google translate service) (206), that can receive various foreign language writings (often relayed by the user's computerized device 204), translate them, and then transmit them back to the user's computerized device (204) for subsequent display.

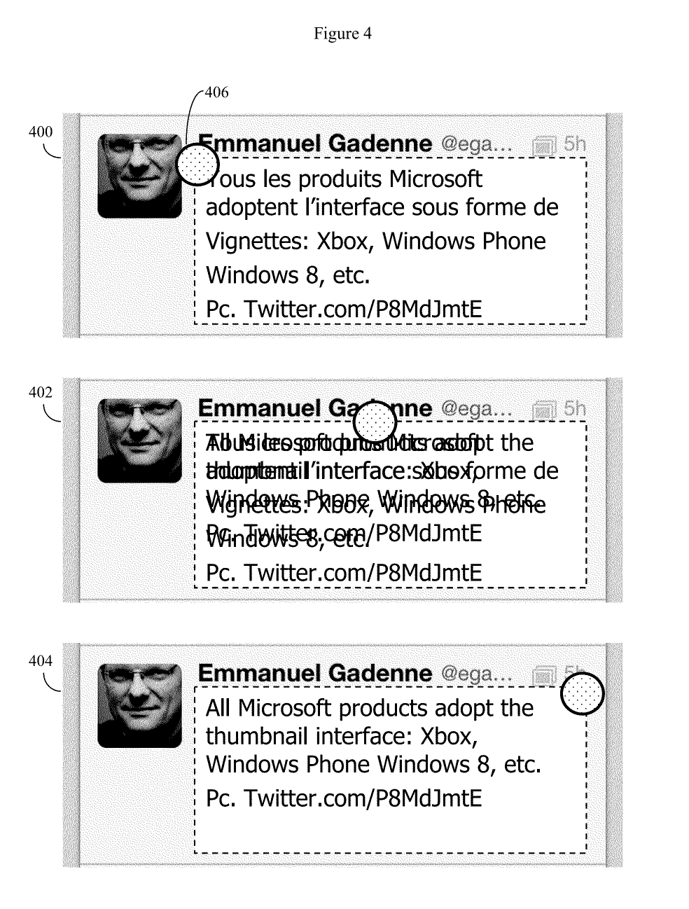

FIG. 4 also shows a stick figure of a user (208), here not to scale. The user is reading the touch sensitive screen (210) of the computerized device (204), and is using his/her hand and finger (212) to touch the first location of the screen (102) and initiate either a “initiate translation” touch command or a “show translation” touch command.

Regardless of if a remote or local computer based language translator is used, the translation system will need to determine both the type of the language that the original foreign language writing (original language writing type) is, as well as the language that the user will desire the writing be translated into (translated language type). Here the translator may itself guess at the original writing language type (e.g. by analyzing the words and determining what language corresponds to those particular words), or alternatively the user's device may directly pass the original language type to the translator using the translator's API.

Here of course, the user's device must itself know the original language type. In some cases, the server (200) that passes the original foreign language writing to the user's device (204) may also at the same time pass the original foreign language type to the user's device as metadata. In this case, the user's device (204) may merely need to parse this metadata, and then pass this original language type to the translator's (206) API.

Similarly the translator (206) must also know the desired translated language type. Here, it often will be useful for the user to set this up in advance on his computerized device (204) as, for example, an app or system user preference setting, so that this desired language type data or metadata is always available for passing to the translator (206). In alternative embodiments, this desired translation type may be inferred from the user's device type (e.g. type of keyboard, location), at least as an initial default setting before the user has officially set their desired translated language type. This desired language type metadata will then also be sent by the user's device (204) to the translator (206).

Once the translator receives the original language writing and either also receives original language types and desired language types, or else infers one or more of these types, the translator (here the computer based translation server 206) will translate the writing and return it to the user's device (204), often via the internet and a wireless link (202), as the translated language writing. This translated language writing will then typically be at least temporarily stored in the computer memory (602) of the user's computerized device (204). As needs be, this translated language writing may be re-retrieved by the user from this memory subsequently as well, thus reducing the load on the language translation server.

In an alternative embodiment, the language translation server (206) may itself monitor the most popular comments from servers (200) serving popular social networks, such as twitter, and translate these in advance, possibly even into a plurality of different language types, and store them in the translation server (206) memory for future use. This way can result in quicker response times because when the user sends a translation request for a popular foreign language writing (e.g. a tweet from a user with a high number of social network followers), the translation will be stored on the server (206) and be immediately available for use.

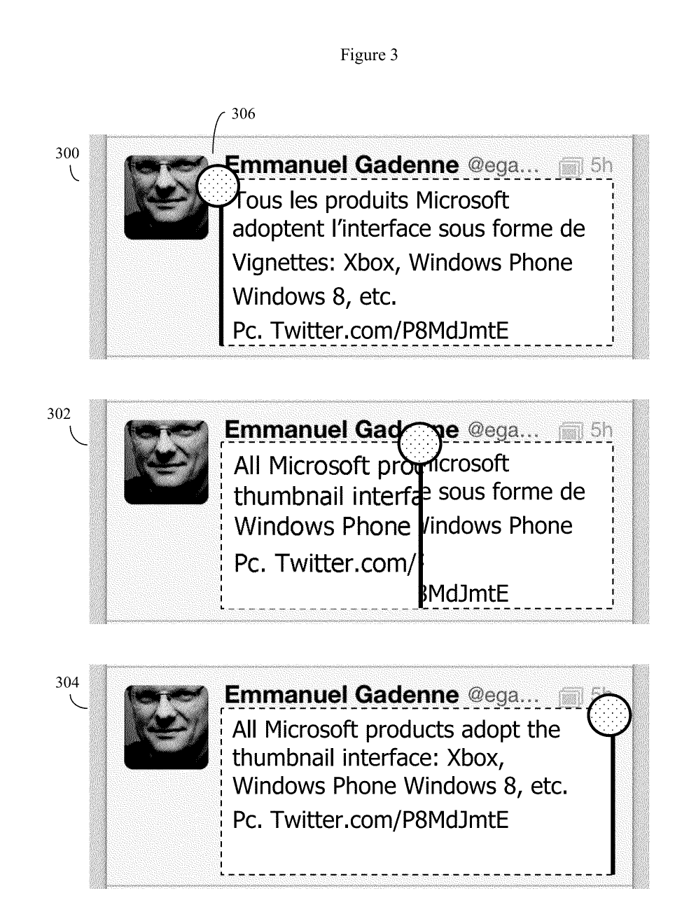

FIG. 3 shows a detail of the French tweet from FIG. 1 (102) (300), here showing the invention's touch controlled translation user interface inaction. Here by moving a finger (212), the user can alternate back and forth between the original French tweet (300), and an English translation of this French tweet (304). The middle of this scrolling process is shown in the middle FIG. 302), which shows a portion of the English translation on the left, and a portion of the original French tweet on the right. Here the result of the user's finger (212) moving the handle graphical element (306) is also shown in various positions. Note that as the handle graphical element (306) moves, it replaces at least some of the original French displayed language from (300) with a corresponding display of the English translation of this writing from (304), and the screen is showing at least portions of the original French language writing and at least portions of the English translated writing at the same time (302).

Thus in FIG. 3, the user drags the handle (306) with his/her finger (212) and the translation appears to the left of the finger. This effect is generally similar to pulling a curtain away from the original text, revealing the translated text. When the user lifts his/her finger from the device's touch screen, this “curtain” can then return, either slowly or quickly or with other animation as desired, back to the left thus once again showing the original language writing before translation.

FIG. 4 again shows a detail of the French tweet from FIG. 1, here showing an alternative embodiment of the invention's touch controlled user interface interaction. Again as before, by moving a finger (212), over an optional handle graphical element (406) the user can cause this portion of the screen to dissolve back and forth between the original French tweet (400) and an English translation of this French tweet (404). The middle of the alternate embodiment dissolve or fade in and fade out process is shown in the middle FIG. 402), which shows a composite of both the English translation and the original French tweet on the screen at the same time.

Alternatively, and particularly useful for the “dissolve in, dissolve out” scheme shown in FIG. 4, the translation may be triggered by a different type of user finger motion, such as a press-hold, double tap, or finger swipe type trigger gesture. This translation can then be held on the screen for a few seconds, and then fade away (i.e. dissolve back to the original language writing) when the user lifts his/her finger or performs another type of finger gesture.

In some cases, the translated language writing will occupy more space than the original language writing. Here the system can respond different ways, depending on default settings or on user settings and preference. In one embodiment, the user's device app may merely reformat the translated language writing to fit the original space, potentially using a smaller font size and/or reformatting as needed. Alternatively the user's device app may increase the size of the bounding box surrounding the translated writing (i.e. make the bounding box surrounding the translated writing larger), and overlap this now larger translated text bounding box on top of, above, or below the bounding box surrounding the original language writing. Alternatively the translation may be shown in a larger bounding box with the rest of the app's user interface below the translation scrolled down to make room to make room for the larger area occupied by the translation.

### DETAILED DISCUSSION

Thus, on a more detailed level, in one embodiment the invention may be a method and also a system and software program product for simultaneously displaying original language writing and translated language writing on the touch sensitive display screen of a computerized device, such as a smartphone or tablet computer (204). This method will generally be used from within a particular computerized device app, or alternatively within a web browser. If a web browser is used, it may be convenient to provide the invention's functionality in the form of a web browser plug-in or extension. Often the method will be used to translate comments from other individuals (e.g. multiple network connected individuals such as from a server (200)) which are being displayed in an app or other type of applications software on the user's device.

The translated language writing will generally be a computer translation (i.e. a machine translation) of the original language writing. The invention will often operate by using the user's computerized device to obtain first obtain the original language writing (e.g. receive a twitter feed, for example from 200), and display this original language writing on a first location, such as a first bounding box (102), of the touch sensitive display screen (210) of the user's computerized device (204).

The method will then obtain, determine, acquire, or deduce the original language type of the original language writing. This original language type can be obtained by, for example, parsing metadata that may have been transmitted from a social network server (200) along with the original language writing, or it may be subsequently deduced by the computerized language translation server (206), a feature commonly available from the API's of commercial translation servers such as the Google translation service.

The method will additionally obtain the user's desired language translation type. This also can be done in various ways. In some embodiments, the user may simply configure his or her computerized device with a default language type. This can be done, for example, in the settings options of an iOS device, or settings equivalent region of an alternative operating system. Alternatively this can also be done on a per-app basis in that app's particular settings section. This desired language translation type can then be transmitted to the language translation server (which may be either remote from the user's computerized device—e.g. 206, or alternatively onboard the user's computerized device). In an alternative embodiment, the language translation server (206) or the app itself can deduce the user's probable desired language type from other data, such as the location of the user's device, hardware configuration of the user's device (e.g. real or virtual keyboard setting), or other indirect data as available.

The user's device (204) can interact with the translation server (206) in different ways. In one embodiment, the user's device may be continually sending original language writing to the translation server in advance of any user indication as to if a translation is desired or not. This embodiment will generally result in less latency because the translation can be done in advance of any user selection, and be available stored onboard the memory (602) of the user's device (204) for use if or when the user desires translation. The drawbacks of this scheme are that it is somewhat inefficient in terms of network bandwidth usage and translation server time utilization, since users may not request that everything be translated.

Alternatively, and as previously discussed, the translation server (206) itself may proactively monitor high popularity original writing servers (200) such as twitter, proactively and speculatively do the translations into various languages in advance, and store the results in server memory so that the translation is instantly available when the translation server receives a translation request from the user's device. This scheme can also reduce latency, but again is also somewhat inefficient in terms of network bandwidth usage and translation server time utilization.

As a third alternative, illustrated in FIG. 2, the user's device (204) will first wait for a user initiate translation type trigger event before sending the original language writing of interest to the translation server (206). Here, since often the same device display screen may show multiple messages (see FIG. 1), the user's device can use the location (first location) (102) of the user initiate translation trigger event on the device's display screen (210) as the signal to initiate translation of the original language writing to the translated language writing.

Here as previously discussed, after the user's device (204) receives the original writing from a network writing source server (200), the method will operate by having the user's device re-transmit the touch selected original language writing to the language translation server (206), either with or without language type metadata (usually depending on if this language type metadata was originally provided by the writing source server), and often with desired language type data. Usually this will be done using either a standard or custom translation API provided by the translation server. This translation server (206) will then use the (supplied or deduced) language type to translate the original language writing into the translated language writing, and then transmit the results back to the user's computerized device (204) using a network such as the internet (202).

This translated language writing will then often be stored in the memory of the computerized device (204) until it is needed by the user. In some embodiments, to improve efficiency and reduce latency, this translated language writing can also be retained in the user computerized device memory (602) for possible reuse in case subsequent translation is requested later.

In an alternative embodiment, the device may be configured to implement a method whereby the user initiate translation input designed to trigger the translation may comprise pressing and holding the press over the original language writing portion of the display screen for a period of time (first holding time), or double tapping, or other trigger event such as a finger swipe over this region. In this embodiment, when this initiate translation trigger event is detected, the device may then assume that the initiate translation trigger event is also a show translation trigger event, and replace the original language writing either gradually or quickly with the translated language writing.

As previously discussed, in some cases, the display screen area occupied by the translated writing could potentially be larger than the area on the display screen occupied by the original language writing. Here the device may automatically resize the font size of the text so that the translated writing will fit within the same area, or alternatively expand the size of the translated writing area on the display screen so that the translated writing fits appropriately.

Upon receiving a user show translation trigger event on the first location of the user device's touch sensitive display screen, according to the method, the device will replace at least portions of the original language writing at this first location with at least portions of the translated language writing, usually at or around the same area of the screen.

This can be done in various ways. As one embodiment, after the user initially taps or otherwise indicates interest in a location of the device's screen that contains the original language writing of interest (102) (300), the user's device may then display a graphic, such as a handle graphical element (306), positioned on the display screen on or near the original language writing of interest. In this embodiment, the user may then request that the device reveal the translated language writing by tapping or dragging this handle, as previously shown in FIG. 3. When the device detects this touch input, the device may then in turn replace at least some of the displayed original language writing with at least some translated language writing. This scheme has the advantage that it can enable the user to control by touching the handle (306) which parts of this screen location display the original language writing, and which parts display the translated language writing. This can be, for example, a moving “curtain” type effect, shown in FIG. 3, or a fade-in fade-out effect, as previously shown in FIG. 4.

Other graphical effects can also be done, and will help make the translation process even more user friendly. For example, in one embodiment based on the “moving curtain” type effect shown in FIG. 3, after the user stops touching the handle graphical element (306), the device can then have the handle element snap or glide back (i.e. quickly or slowly) back to its original position, once again showing the original language writing. Here the graphical effect can be similar to a curtain closing.

Alternatively, and as previously discussed, the translated writing can dissolve in or out over the original language writing. Here, for example, in one embodiment based on the dissolve in and out effect shown in FIG. 4, after the user stops touching the foreign language portion (first location) of the display screen (102), the portion of the display screen (first location) that displays the translation can be replaced (404), again either gradually (402) or abruptly, with the original language writing (400). Alternatively this can be done in reverse, so that the portion of the display screen (first location again) that displays the original language writing (400) are replaced either gradually (402) or abruptly with the translated writing (404).

In any event, regardless of which embodiment is used, according to the invention's methods, often the net result will be to produce, for at least a transient period of time, a composite first location on the device's display screen where at least portions of the original language writing and the translated language writing co-exist (e.g. 302, 402).

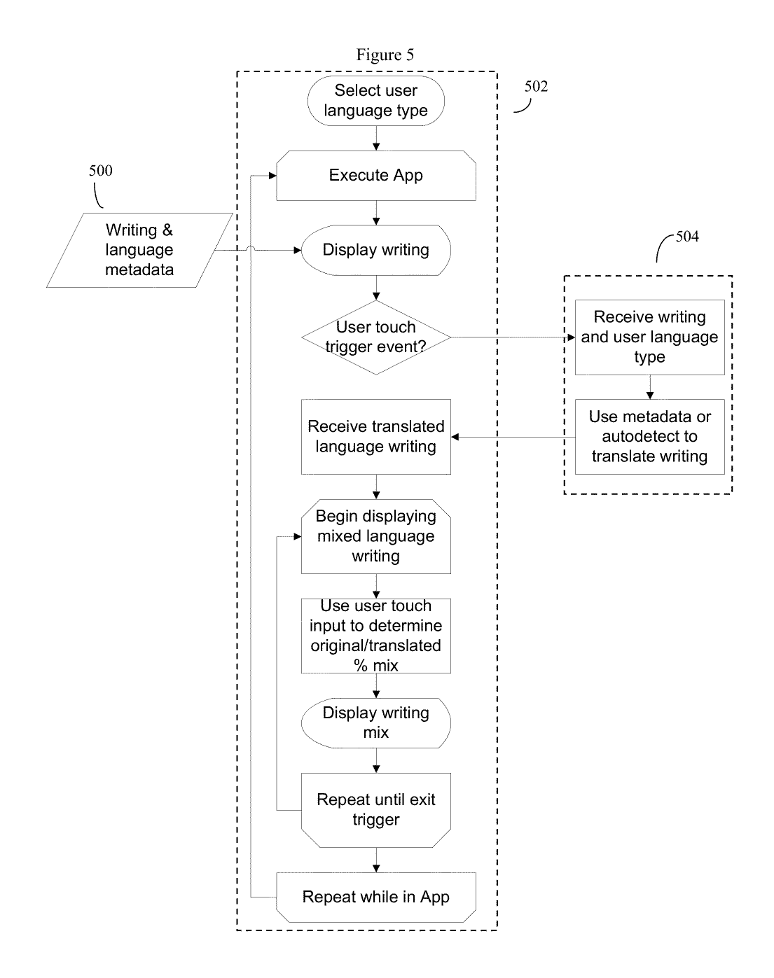

FIG. 5 shows a flow chart showing some of the various software steps performed by the user's computerized device in response to foreign language writing input and touch input from the user, as well as showing how the system interacts with a remote translator server. Here the writing and language metadata (500) can come from the remote server (200). The steps in box (502) will generally take place on the user's computerized device (204). The steps in box (504) will often take place on the translation server (206), but may in some embodiments be done on a language translator onboard device (204)

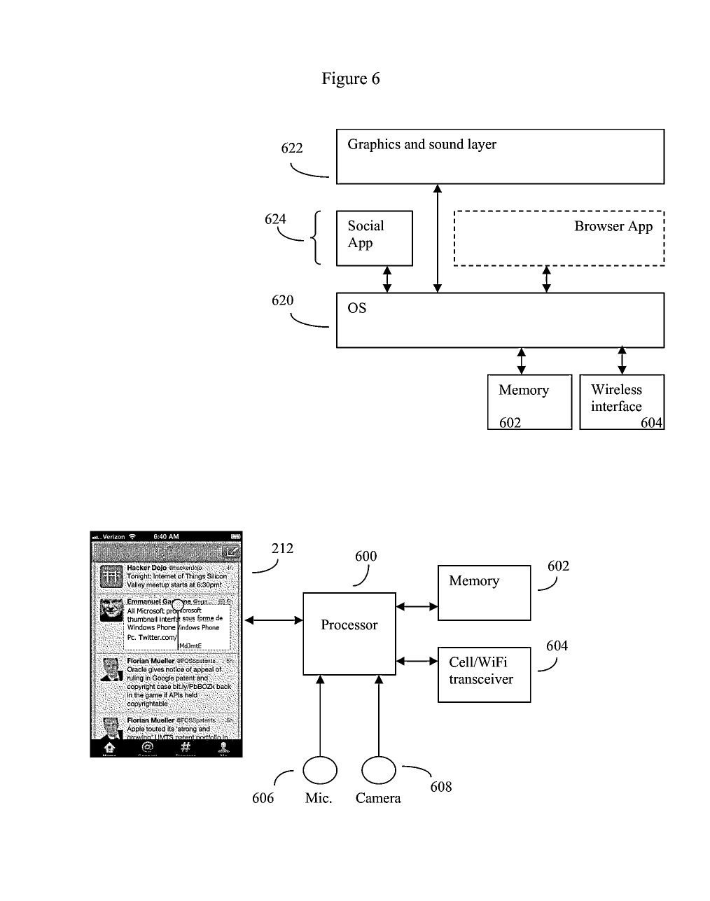

FIG. 6 shows a detail of some of the major software and hardware components of the user's touch screen equipped computerized device, in this case a smartphone. The computerized device (204) will generally comprise a touch sensitive display screen (210), a processor (600), memory (602), network interface devices (e.g. a wireless cellular phone/WiFi transceiver) (604), as well as other peripherals such as a microphone (606) and camera (608).

FIG. 6 also shows a simplified software model of some of the major software modules or layers of the computerized device. The device software may often consist of an operating system layer (620) which interacts with system memory (602) and the system wireless interface (604). The touch screen input and output is often controlled by a graphics and sound layer of software (622). Various apps (624), such as a twitter-like social media app, or an internet browser like apps generally can be usefully viewed as making use of the API provided by the operating system layer. The apps will often interact with the graphics and sound layer though the OS layer, although in some cases direct reading and writing to the graphics and sound layer and devices may also be permitted.

Depending on the embodiment, the invention's methods may be implemented only at the app level (624), at the OS level (620), or at both levels (620, 624).

1. A method of simultaneously displaying original language writing and translated language writing on the touch sensitive display screen of a computerized device, said translated language writing corresponding to a computer translation of said original language writing, said method comprising:
using a computerized device to obtain said original language writing;
displaying said original language writing on a first location of said touch sensitive display screen of said computerized device;
obtaining the original language type of said original language writing;
obtaining the user's desired translated language type;
either before or upon receiving a user initiate translation trigger event on said first location of said touch sensitive display screen, using said original language type, said desired translated language type, and at least one computer processor and memory to automatically translate said original language writing to said translated language writing;
upon receiving a user show translation trigger event on said first location of said touch sensitive display screen, replacing at least portions of said original language writing on said first location of said touch sensitive display screen with at least portions of said translated language writing on said first location of said touch sensitive display screen, thus producing at least transiently a composite first location of said touch sensitive display screen displaying both at least portions of said original language writing and at least portions of said translated language writing.

2. The method of claim 1, wherein said first location of said touch sensitive display screen additionally displays, either before or after a user tap on said first location, at least one handle graphical element disposed proximate said original language writing;
said user show translation trigger event comprises tapping and/or dragging said at least one handle graphical element; and
according to the user dragging of said at least one handle graphical element, replacing at least some of said displayed original language writing with a corresponding display of said translated language writing;
thus enabling said user to control by touch which parts of said first location display said original language writing, and which parts of said first location display said translated language writing.

3. The method of claim 2, wherein after said user stops touching said at least one handle graphical element, said at least one handle element moves back to its original position either abruptly or slowly, or with a corresponding animation, thereby replacing those parts of said first location that display said translated language writing with corresponding original language writing.

4. The method of claim 2, wherein said user stops touching said first location of said display screen,
either those parts of said first location that display said translated language writing are replaced either abruptly or gradually by said original language writing; or
those parts of said first location that display said original language writing are replaced either abruptly or gradually by said translated language writing.

5. The method of claim 1, wherein said user show translation trigger event comprises pressing on said first location of said touch sensitive display screen for at least a first holding period of time, or double tapping on said first location of said touch sensitive display screen, or other trigger gesture; and
wherein in response to said user show translation trigger event, said original language writing in said first location is rapidly or gradually replaced by said translated language writing.

6. The method of claim 1, wherein if the display screen area occupied by said translated writing is larger than said area of said first location occupied by said original language writing, then further enlarging said area of said first location to fit the larger display screen area that is occupied by said translated writing.

7. The method of claim 1, further transmitting said original language writing to said computerized device using a computer network either with or without original language type metadata;
using said computerized device to retransmit said original language writing to the API of a computerized language translation server;
using said computerized language translation server and said desired language type to translate said original language writing into said translated language writing;
and using a computer network to transmit said translated language writing back to said computerized device.

8. The method of claim 7, further using said computerized language translation server to determine the original language type of said original language writing.

9. The method of claim 7, wherein said user configures said computerized device with a default desired language type;
and said computerized device further transmits said default desired language type to said computerized language translation server for use as said desired language type; or
wherein said computerized language translation server automatically sets said desired language type based on the network address, location, or other characteristics of said computerized device.

10. The method of claim 1, further storing said translated language writing in the memory of said computerized device so that future user translation requests for a translation of said original language writing may use translated language writing retrieved directly from said memory.

11. The method of claim 1, further using said method to translate comments from multiple network connected individuals that are being displayed in a smartphone or tablet computer based app.

12. The method of claim 1, used as a web browser plug-in or extension or other software module for a smartphone or tablet computer based internet browser.

13. A method of simultaneously displaying original language writing and translated language writing on a touch sensitive display screen of a computerized device, said translated language writing corresponding to a computer translation of said original language writing, said method comprising:
transmitting at least one original language writing to said computerized device using a computer network, either with or without original language type metadata;
displaying said original language writing on a first location of said touch sensitive display screen of said computerized device;
obtaining the original language type of said original language writing by either obtaining said original language type from metadata transmitted along with said original language writing, or using a computerized language translation server to determine the original language type of said original language writing;
obtaining the user's desired translated language type by either
reading said user default desired language type from said computerized device, and using said computerized device to transmit said default desired language type to said computerized language translation server for use as said desired language type, or
using said computerized language translation server to automatically set said desired language type based on the network address, location, or other characteristics of said computerized device;
either before or upon receiving a user initiate translation trigger event on said first location of said touch sensitive display screen, using said original language type, said desired translated language type, and at said language translation server's at least one computer processor and memory to automatically translate said original language writing to said translated language writing by the steps of:
a: using said computerized device to retransmit said original language writing to the API of a computerized language translation server;
b: using said computerized language translation server and said desired language type to translate said original language writing into said translated language writing;
c: and using a computer network to transmit said translated language writing back to said computerized device.
upon receiving a user show translation trigger event on said first location of said touch sensitive display screen, replacing at least portions of said original language writing on said first location of said touch sensitive display screen with at least portions of said translated language writing on said first location of said touch sensitive display screen, thus producing at least transiently a composite first location of said touch sensitive display screen displaying both at least portions of said original language writing and at least portions of said translated language writing.

14. The method of claim 13, wherein said first location of said touch sensitive display screen additionally displays, either before or after a user tap on said first location, at least one handle graphical element disposed proximate said original language writing;
said user show translation trigger event comprises tapping and/or dragging said at least one handle graphical element; and
according to the user dragging of said at least one handle graphical element, replacing at least some of said displayed original language writing with a corresponding display of said translated language writing;
thus enabling said user to control by touch which parts of said first location display said original language writing, and which parts of said first location display said translated language writing.

15. The method of claim 14, wherein after said user stops touching said at least one handle graphical element, said at least one handle element moves back to its original position either abruptly or slowly, or with a corresponding animation, thereby replacing those parts of said first location that display said translated language writing with corresponding original language writing.

16. The method of claim 14, wherein said user stops touching said first location of said display screen,
either those parts of said first location that display said translated language writing are replaced either abruptly or gradually by said original language writing; or
those parts of said first location that display said original language writing are replaced either abruptly or gradually by said translated language writing.

17. The method of claim 13, wherein said user show translation trigger event comprises pressing on said first location of said touch sensitive display screen for at least a first holding period of time, or double tapping on said first location of said touch sensitive display screen, or other trigger gesture; and
wherein in response to said user touch trigger event, said original language writing in said first location is rapidly or gradually replaced by said translated language writing.

18. The method of claim 13, wherein if the display screen area occupied by said translated writing is larger than said area of said first location occupied by said original language writing, then further enlarging said area of said first location to fit the larger display screen area that is occupied by said translated writing.

19. A method of simultaneously displaying original language writing and translated language writing on the touch sensitive display screen of a computerized device, said translated language writing corresponding to a computer translation of said original language writing, said method comprising:
transmitting at least one original language writing to said computerized device using a computer network either with or without original language type metadata;
displaying said original language writing on a first location of said touch sensitive display screen of said computerized device;
obtaining the original language type of said original language writing by either obtaining said original language type from metadata transmitted along with said original language writing, or using a computerized language translation server to determine the original language type of said original language writing;
obtaining the user's desired translated language type by either
reading said user default desired language type from said computerized device, and using said computerized device to transmit said default desired language type to said computerized language translation server for use as said desired language type, or
using said computerized language translation server to automatically set said desired language type based on the network address, location, or other characteristics of said computerized device;
either before or upon receiving a user initiate translation trigger event on said first location of said touch sensitive display screen, using said original language type, said desired translated language type, and at said language translation server's at least one computer processor and memory to automatically translate said original language writing to said translated language writing by the steps of:
a: using said computerized device to retransmit said original language writing to the API of a computerized language translation server;
b: using said computerized language translation server and said desired language type to translate said original language writing into said translated language writing;
c: and using a computer network to transmit said translated language writing back to said computerized device.
upon receiving a user show translation trigger event on said first location of said touch sensitive display screen, replacing at least portions of said original language writing on said first location of said touch sensitive display screen with at least portions of said translated language writing on said first location of said touch sensitive display screen, thus producing at least transiently a composite first location of said touch sensitive display screen displaying both at least portions of said original language writing and at least portions of said translated language writing;
wherein said first location of said touch sensitive display screen additionally displays, either before or after a user tap on said first location, at least one handle graphical element disposed proximate said original language writing;
said user show translation trigger event comprises tapping and/or dragging said at least one handle graphical element;
according to the user dragging of said at least one handle graphical element, replacing at least some of said displayed original language writing with a corresponding display of said translated language writing;
thus enabling said user to control by touch which parts of said first location display said original language writing, and which parts of said first location display said translated language writing; and
wherein after said user stops touching said at least one handle graphical element, said at least one handle element moves back to its original position either abruptly or slowly, or with a corresponding animation, thereby replacing those parts of said first location that display said translated language writing with corresponding original language writing.

20. The method of claim 19, wherein if the display screen area occupied by said translated writing is larger than said area of said first location occupied by said original language writing, then further enlarging said area of said first location to fit the larger display screen area that is occupied by said translated writing.
